(19) United States
(12) Patent Application Publication
(10) Pub. No.: US 2004/0229163 A1
(43) Pub. Date: Nov. 18, 2004

(54) Lithographic printing plate precursor requiring no fountain solution

(76) Inventors: Koji Sonokawa, Shizuoka (JP); Tatsuya Nomura, Shizuoka (JP)

Correspondence Address: BIRCH STEWART KOLASCH & BIRCH, PO BOX 747, FALLS CHURCH, VA, 22040-0747, US

(21) Appl. No.: 10/844,454

(22) Filed: May 13, 2004

(30) Foreign Application Priority Data
May 16, 2003 (JP) 2003-139323

(51) Int. Cl. G03C 1/76

(52) U.S. Cl. 430/271.1

(57) ABSTRACT

A lithographic printing plate precursor requiring no fountain solution, comprising, in this order: a back layer containing a particle having an average particle size of 0.2 to 4.0 μm; a support; a light-to-heat conversion layer; and a silicone rubber layer, wherein a dynamic friction coefficient between a surface of the back layer and a surface of a plate cylinder of a press on which the lithographic printing plate precursor is to be loaded is from 0.17 to 0.26.

### FIELD OF THE INVENTION

The present invention relates to a high-sensitivity lithographic printing plate precursor requiring no fountain solution (hereinafter, called a “waterless lithographic printing plate precursor”), where an image can be formed by heat-mode recording using a laser ray and printing can be performed without requiring a fountain solution. More specifically, the present invention relates to a waterless lithographic printing plate precursor free from a problem of failure in the plate-spooling amount and four-color registration in an embodiment such that a waterless lithographic printing plate precursor in the roll form is loaded inside a plate cylinder of a press, supplied onto the plate cylinder while directing the printing surface of the waterless lithographic printing plate precursor to the surface side and spooled to position a new surface of the waterless lithographic printing plate precursor in the printing region on the plate cylinder, a laser is imagewise scanned on the plate cylinder and after removing the silicone rubber layer in the laser-irradiated part, printing is preformed.

### BACKGROUND OF THE INVENTION

Conventional printing systems requiring a fountain solution have serious problems, for example, the delicate balance between fountain solution and ink is difficult to control or the ink undergoes emulsification or is mixed with fountain solution to cause ink concentration failure, background staining or paper loss. On the other hand, the waterless lithographic printing plate does not require a fountain solution and therefore, has many advantages.

In recent years, with abrupt progress of pre-press systems and output systems such as image setter and laser printer, techniques of converting a printing image into digital data and obtaining a printing plate by a new plate-making method such as computer-to-plate and computer-to-cylinder have been proposed. For these printing systems, a new type printing material is demanded and being developed.

Examples of the laser writing technique capable of forming a waterless lithographic printing plate precursor include a system where a printing plate precursor is produced by providing an ink-repellent silicone rubber layer on a layer containing a laser ray absorbent such as carbon black and a binder or on a layer comprising a metal thin layer and capable of converting light into heat (hereinafter, called a “light-to-heat conversion layer”), and a laser ray is irradiated thereon, as a result, the silicone rubber layer in the irradiated part is removed to form an ink-attaching region (image area) and the non-irradiated, silicone rubber layer-remaining region forms an ink-repellent region (non-image area), thereby enabling waterless printing.

Such a waterless lithographic printing plate precursor is advantageous in that the production cost is low and since the image is formed by using ablation of the light-to-heat conversion layer in the laser-irradiated part, the gas generated pushes up the silicone rubber layer in the laser-irradiated part and the removal of silicone rubber layer in the laser-irradiated part at the subsequent development (hereinafter, called a “developability”) can be efficiently performed.

Also, an embodiment where such a waterless lithographic printing plate precursor in the roll form is loaded inside a plate cylinder of a press, supplied onto the plate cylinder while directing the printing surface of the waterless lithographic printing plate precursor to the surface side and spooled to position a new surface of the waterless lithographic printing plate precursor in the printing region on the plate cylinder, a laser is imagewise scanned on the plate cylinder and after removing the silicone rubber layer in the laser-irradiated part, printing is preformed, is disclosed (see, for example, International Publication No. 90/02045).

### SUMMARY OF THE INVENTION

However, on use of the above-described waterless lithographic printing plate precursor in the embodiment described in International Publication No. 90/02045, troubles such as blocking and conveyance failure readily occur in the step of winding the plate material around the circumference of plate cylinder, the recording step of performing writing by a laser, respective steps of development, water washing and drying, and the printing step. For example, at the winding of a plate material around the circumference of a plate cylinder, electrostatic charging and conveyance trouble are caused due to friction between the plate material and the plate cylinder surface and this gives rise to an excess or short plate-spooling amount or improper four-color registration.

Accordingly, an object of the present invention is to solve the problems of a waterless lithographic printing plate precursor which performs image formation by using the ablation, and provide a waterless lithographic printing plate precursor free from troubles due to electrostatic charge in the production step, writing step, printing step and the like and at the same time, free from the problem of failure in the plate-spooling amount and four-color registration due to a conveyance trouble.

In particular, the object of the present invention is to provide a waterless lithographic printing plate precursor free from the problem of failure in the plate-spooling amount and four-color registration in an embodiment where a waterless lithographic printing plate precursor in the roll form is loaded inside a plate cylinder of a press, supplied onto the plate cylinder while directing the printing surface of the waterless lithographic printing plate precursor to the surface side and spooled to position a new surface of the waterless lithographic printing plate precursor in the printing region on the plate cylinder, a laser is imagewise scanned on the plate cylinder and after removing the silicone rubber layer in the laser-irradiated part, printing is preformed.

As a result of intensive investigations, the present inventors found it important to specify the kind of the particle contained in the back layer of a waterless lithographic printing plate precursor, the range of the particle size thereof, and the range of the dynamic friction coefficient between the plate cylinder surface of a press and the back surface of the waterless lithographic printing plate precursor. The present invention has been accomplished based on this finding.

That is, the present invention is:

(1) a waterless lithographic printing plate precursor comprising a support having sequentially stacked thereon at least a light-to-heat conversion layer and a silicone rubber layer, wherein a back layer containing a particle having an average particle size of 0.2 to 4.0 μm is provided on the support in the side opposite the light-to-heat conversion layer and silicone rubber layer and the dynamic friction coefficient between the surface of the back layer and the surface of a plate cylinder of a press on which the lithographic printing plate precursor is loaded is from 0.17 to 0.26.

Preferred embodiments of the present invention are as follows.

(2) The waterless lithographic printing plate precursor as described in (1) above, wherein the particle is a matting agent.

(3) The waterless lithographic printing plate precursor as described in (1) above, wherein the back layer further contains a metal oxide particle.

(4) The waterless lithographic printing plate precursor as described in (3) above, wherein the metal oxide particle has an average particle size of 0.02 to 0.2 μm.

The waterless lithographic printing plate precursor of the present invention can realize printing of not causing a conveyance trouble, four-color registration failure or the like in an embodiment where the waterless lithographic printing plate precursor in the roll form is loaded inside a plate cylinder of a press and supplied onto the plate cylinder while directing the image-forming surface to the surface side, the formation of an image pattern and plate-making of a lithographic printing plate are performed on the press by scan-exposing an image with an infrared laser ray based on digital signals, and printing is performed by using the printing plate on the same press.

### DETAILED DESCRIPTION OF THE INVENTION

The waterless lithographic printing plate precursor of the present invention is described in detail below.

The constitution of the waterless lithographic printing plate precursor of the present invention is described. In the waterless lithographic printing plate precursor of the present invention, at least a light-to-heat conversion layer and a silicone rubber layer are sequentially stacked on a support and a back layer is provided on the support in the side opposite the light-to-heat conversion layer and silicone rubber layer. The term “sequentially stacked” as used herein means that those layers are stacked in the above-described order, and this does not deny the presence of other layers such as undercoat layer, overcoat layer and interlayer.

The back layer, which is a characteristic constitutional element of the waterless lithographic printing plate precursor of the present invention, is described below.

[Back Layer]

In the waterless lithographic printing plate precursor of the present invention, at least one back layer is provided on the support in the side opposite the surface where the light-to-heat conversion layer and the silicone rubber layer are provided. This back layer contains a particle having an average particle size of 0.2 to 4.0 μm (specific particle size) and is characterized in that the dynamic friction coefficient between the surface of the back layer and the surface of a plate cylinder of a press on which the waterless lithographic printing plate precursor is loaded is from 0.17 to 0.26.

The average particle size of the particle having a specific particle size is preferably from 0.3 to 3.0 μm, more preferably from 0.5 to 1.0 μm.

If the average particle size of the particle having a specific particle size is less than 0.2 μm or exceeds 4.0 μm, four-color registration failure is caused though the mechanism is not clear, and this is not improper.

In the present invention, the dynamic friction coefficient between the surface of the back layer of the waterless lithographic printing plate precursor and the surface of a plate cylinder of a press on which the waterless lithographic printing plate precursor is loaded is preferably from 0.18 to 0.24, more preferably from 0.19 to 0.22.

If the dynamic friction coefficient between the surface of the back layer of the waterless lithographic printing plate precursor and the surface of a plate cylinder of a press on which the waterless lithographic printing plate precursor is loaded is less than 0.17, blocking with the plate cylinder readily occurs to give an insufficient plate-conveying amount, whereas if it exceeds 0.26, the plate-conveying amount becomes excessively large. Thus, these both are improper.

The back layer of the waterless lithographic printing plate precursor of the present invention is in the form such that the above-described particle having a specific particle size is dispersed in a cured product of binder such as binder resin, and the particle having a specific particle size contained in the back layer is one of the factors of giving a dynamic friction coefficient of 0.17 to 0.26 between the surface of the back layer and the surface of a plate cylinder of a press where the lithographic printing plate precursor is loaded.

The particle having a specific particle size contained in the back layer is not particularly limited but is preferably a matting agent.

The matting agent is not particularly limited, but preferred examples thereof include oxides such as silicon oxide, aluminum oxide and magnesium oxide, and polymers or copolymers such as polymethyl methacrylate and polystyrene. In particular, a crosslinked particle of such a polymer or copolymer is more preferred.

By containing this matting agent in a predetermined amount, the Bekk smoothness (seconds) on the surface in the back layer side can be adjusted to 50 to 500 seconds, preferably from 60 to 450 seconds, more preferably from 200 to 400 seconds. The “Bekk smoothness (seconds) on the surface in the back layer side” as used herein means a value measured by the method descried in JIS-P8119-1998 and J. TAPPI Paper Pulp Test Method No. 5. When the Bekk smoothness (seconds) on the surface in the back layer side is 50 seconds or more, excessively large unevenness is not present on the surface in the back side, the matting agent is not easily fallen from the layer and the conveyance property of the waterless lithographic printing plate precursor does not decrease in aging. On the other hand, when the Bekk smoothness (seconds) on the surface in the back layer side is 500 seconds or less, the smoothness in the back layer side is not excessively high, the conveyance property of the waterless lithographic printing plate precursor does not decrease, and various troubles accompanying conveyance failure are not caused.

The back layer of the waterless lithographic printing plate precursor of the present invention preferably contains a metal oxide particle. This metal oxide particle is electrically conducting and imparts an antistatic property to the waterless lithographic printing plate precursor of the present invention.

Examples of the construction material for this metal oxide particle (hereinafter also called an “electrically conducting metal oxide particle”) include ZnO, TiO₂, SnO₂, Al₂O₃, In₂O₃, MgO, BaO, MoO₃, a composite oxide thereof, and a metal oxide when the above-described metal oxide further contains a heteroatom.

The metal oxide is preferably SnO₂, ZnO, Al₂O₃, TiO₂, In₂O₃ or MgO, more preferably SnO₂, ZnO, In₂O₃ or TiO₂, still more preferably SnO₂. Examples of the metal oxide containing a small amount of heteroatom include those obtained by doping from 0.01 to 30 molt (preferably from 0.1 to 10 molt) of a heteroatom such as Al or In to ZnO, Nb or Ta to TiO₂, Sn to In₂O₃, or Sb, Nb or halogen atom to SnO₂. When the amount of the heteroatom added is 0.01 mol % or more, a sufficiently high electric conductivity can be imparted to the oxide or composite oxide, and when 30 mol % or less, the blackening degree of the particle does not increase and the back layer can be prevented from blackening and suitably used for a photosensitive material. Accordingly, the material for the electrically conducting metal oxide particle for use in the present invention is preferably a metal oxide or a composite metal oxide containing a small amount of a heteroatom. Also, those having an oxygen defect in the crystal structure are preferred.

The electrically conducting metal oxide particle is preferably contained in the back layer in an amount of 10 to 1,000 wt %, more preferably from 100 to 800 wt %, based on the binder which is described later. When the content is 10 wt % or more, a sufficiently high antistatic property can be obtained, and when 1,000 wt % or less, the electrically conducting metal oxide particle can be prevented from falling from the back layer of the plate material.

The particle size of the electrically conducting metal oxide particle is preferably smaller so as to reduce the light scattering as much as possible, but this should be determined by using, as a parameter, the ratio in the refractive index between the particle and the binder. The particle size can be obtained according to the Mie's theory.

The average particle size of the metal oxide particle in the back layer of the waterless lithographic printing plate precursor of the present invention is preferably from 0.03 to 0.15 μm, more preferably from 0.04 to 0.08 μm. The average particle size as used herein is a value including not only the primary particle size of the electrically conducting metal oxide particle but also the particle size of higher order structures.

When the average particle size of this particle is 0.02 μm or more, this is advantageous from the standpoint of adjusting the dynamic friction coefficient, and when 0.20 μm or less, falling from the back layer can be prevented. Thus, these are both proper.

In adding the fine metal oxide particle to the coating solution for forming the back layer, the fine metal oxide particle may be added as it is and dispersed, but a dispersion obtained by dispersing the fine metal oxide particle in a solvent such as water (if desired, containing a dispersant and a binder) is preferably added.

In the present invention, the metal oxide particle is contained in the back layer, whereby the surface electric resistance value at 10° C. and 15% RH in the back layer side of the printing plate precursor can be adjusted to 1×10⁷ to 1×10¹² Ω, preferably from 1×10⁹ to 1×10¹¹ Ω. Furthermore, the surface resistance value at a high temperature and a high humidity can also be adjusted to a predetermined value. When the surface electric resistance value at 10° C. and 15% RH in the back layer side of the waterless lithographic printing plate precursor is 1×10⁷ or more, the electrically conducting metal oxide particle needs not be added in a large amount and this particle does not easily fall, as a result, secondary failures such that the fallen particle serves as a core of repelling of the coated film are not caused. Also, when 1×10¹² Ω or less, the desired antistatic property can be maintained even at a high temperature and a high humidity to prevent occurrence of coating failure at the production of the waterless lithographic printing plate precursor at a high temperature and a high humidity and furthermore, the laser ray at the writing and recording can be prevented from coming out of focus due to attachment of dust or the like to the waterless lithographic printing plate precursor, so that the sharpness (reproducibility) of image recording can be enhanced.

The binder for use in the back layer of the waterless lithographic printing plate precursor of the present invention is not particularly limited but is preferably a cured product of an acrylic resin with a melamine compound. In the present invention, from the standpoint of maintaining good working environment and preventing air pollution, the polymer and the melamine compound both are preferably water-soluble or preferably used in the water dispersion state such as emulsion. Furthermore, the polymer preferably has any one group selected from a methylol group, a hydroxyl group, a carboxyl group and a glycidyl group so as to enable a crosslinking reaction with the melamine compound. Among these groups, a hydroxyl group and A carboxyl group are preferred, and a carboxyl group is more preferred. The content of the hydroxyl group or carboxyl group in the polymer is preferably from 0.0001 to 10 equivalent/1 kg, more preferably from 0.01 to 1 equivalent/1 kg.

Examples of the acrylic resin include a homopolymer of any one monomer selected from an acrylic acid, acrylic acid esters such as alkyl acrylate, an acrylamide, an acrylonitrile, a methacrylic acid, methacrylic acid esters such as alkyl methacrylate, a methacrylamide and a methacrylonitrile, and a copolymer obtained by the polymerization of two or more of these monomers. Among these, a homopolymer of any one monomer selected from acrylic acid esters such as alkyl acrylate and methacrylic acid esters such as alkyl methacrylate, and a copolymer obtained by the polymerization of two or more of these monomers are preferred. Examples thereof include a homopolymer of any one monomer selected from acrylic acid esters and methacrylic acid esters each containing an alkyl group having from 1 to 6 carbon atoms, and a copolymer obtained by the polymerization of two or more of these monomers.

The acrylic resin is a polymer mainly comprising the above described composition and being obtained by partially using, for example, a monomer having any one group selected from a methylol group, a hydroxyl group, a carboxyl group and a glycidyl group so as to enable a crosslinking reaction with the melamine compound.

Examples of the melamine compound which can be used in the present invention include compounds having two or more (preferably three or more) methylol or alkoxymethyl groups within the melamine molecule, and condensation polymers thereof such as melamine resin and melamine/urea resin.

Examples of the initial condensate of melamine and formalin include dimethylolmelamine, trimethylolmelamine, tetramethylolmelamine, pentamethylolmelamine and hexamethylolmelamine. Specific examples of the commercially available product thereof include, but are not limited to, Sumitex Resin M-3, Mw, MK and MC (produced by Sumitomo Chemical Co., Ltd.).

Examples of the condensation polymer include hexamethylolmelamine resin, trimethylolmelamine resin and trimethyloltrimethoxymethylmelamine resin. Examples of the commercially available product thereof include, but are not limited to, MA-1 and MA-204 (produced by Sumitomo Bakelite Co., Ltd.), Beckamine MA-S, Beckamine APM and Beckamine J-101 (produced by Dai-Nippon Ink & Chemicals, Inc.), Euroid 344 (produced by Mitsui Toatsu Chemicals Inc.), Ohka Resin M31 and Ohka Resin PWP-8 (produced by Ohka Shinko K.K.).

The melamine compound preferably has a functional equivalent of 50 to 300 as expressed by a value obtained by dividing the molecular weight by the number of functional groups within one molecule. The functional group here indicates a methylol group or an alkoxymethyl group. With a functional equivalent of 300 or less, an appropriate curing density and high strength can be obtained, and with a functional equivalent of 50 or more, a proper curing density is obtained and the properties are improved without impairing the transparency. The amount of the aqueous melamine compound added is from 0.1 and 100 wt %, preferably from 10 and 90 wt %, based on the above-described polymer.

These melamine compounds may be used individually or in combination of two or more thereof or may be used in combination with other compounds and examples thereof include curing agents described in C. E. K. Meers and T. H. James, The Theory of Photographic Process, 3rd ed. (1966), U.S. Pat. Nos. 3,316,095, 3,232,764, 3,288,775, 2,732,303, 3,635,718, 3,232,763, 2,732,316, 2,586,168, 3,103,437, 3,017,280, 2,983,611, 2,725,294, 2,725,295, 3,100,704, 3,091,537, 3,321,313, 3,543,292 and 3,125,449, and British Patents 994,869 and 1,167,207.

Representative examples thereof include, but are not limited to, aldehyde-base compounds and derivatives thereof, such as mucochloric acid, mucobromic acid, mucophenoxychloric acid, mucophenoxybromic acid, formaldehyde, glyoxal, monomethylglyoxal, 2,3-dihydroxy-1,4-dioxane, 2,3-dihydroxy-5-methyl-1,4-dioxane succinaldehyde, 2,5-dimethoxytetrahydrofuran and glutaraldehyde;

active vinyl-base compounds such as divinylsulfone-N,N′-ethylenebis(vinylsulfonylacetamide), 1,3-bis (vinylsulfonyl)-2-propanol, methylenebismaleimide, 5-acetyl-1,3-diacryloylhexahydro-s-triazine, 1,3,5-triacryloylhexahydro-s-triazine and 1,3,5-trivinylsulfonylhexahydro-s-triazine;

active halogen-base compounds such as 2,4-dichloro-6-hydroxy-s-triazine sodium salt, 2,4-dichloro-6-(4-sulfoanilino)-s-triazine sodium salt, 2,-dichloro-6-(2-sulfoethylamino)-s-triazine and N,N′-bis(2-chloroethyl-carbamyl) piperazine;

epoxy compounds such as bis(2,3-epoxypropyl)methyl-propylammonium p-toluenesulfonate, 1,4-bis (21,3-epoxypropyloxy)butane, 1,3,5-triglycidyl isocyanurate, 1,3-glycidyl-5-(γ-acetoxy-β-oxypropyl) isocyanurate, sorbitol polyglycidyl ethers, polyglycerol polyglycidyl ethers, pentaerythritol polyglycidyl ethers, di glycerol polyglycidyl ether, 1,3,5-triglycidyl(2-hydroxyethyl) isocyanurate, glycerol polyglycerol ethers and trimethylolpropane polyglycidyl ethers;

ethyleneimine-base compounds such as 2,4,6-triethylene-s-triazine, 1,6-hexamethylene-N,N′-bisethylene-urea and bis-α-ethyleneiminoethyl thioether; methane-sulfonic acid ester-base compounds such as 1,2-di(methane-sulfonoxy)ethane, 1,4-di(methanesulfonoxy)butane and 1,5-(methanesulfonoxy)pentane; carbodiimide compounds such as dicyclohexylcarbodiimide and 1-dicyclohexyl-3-(3-trimethylaminopropyl)carbodiimide hydrochloride; isoxazole-base compounds such as 2,5-dimethylisoxazole; inorganic compounds such as chromium alum and chromium acetate;

dehydrating condensation-type peptide reagents such as N-carboethoxy-2-isopropoxy-1,2-dihydroquinoline and N-(1-morpholinocarboxy)-4-methylpyridinium chloride; active ester-base compounds such as N,N′-adipoyldioxydisuccinimide and N,N′-terephthaloyldioxydisuccinimide; isocyanates such as toluene-2,4-diisocyanate and 1,6-hexamethylene diisocyanate; and epichlorohydrin-base compounds such as polyamido-polyamide-epichlorohydrin reaction product.

In the back layer of the waterless lithographic printing plate precursor of the present invention, a lubricant may be contained as auxiliary means so that the dynamic friction coefficient between the surface of the back layer and the surface of a plate cylinder of a press on which the plate material is loaded can be made to fall within the range from 0.17 to 0.26.

Examples of the lubricant includes a surfactant and a wax. Examples of the surfactant include known anionic surfactants, cationic surfactants, amphoteric surfactants and nonionic surfactants. The wax is not particularly limited, but examples thereof include so-called waxes which are an ester of a fatty acid with a higher monohydric or dihydric alcohol, and also include those described below having an appropriate melting point, which are generically defined as containing an organic compound having the same functions as wax.

As an aliphatic ester, specific examples thereof include methyl undecylate, ethyl undecylate, methyl laurate, ethyl laurate, vinyl laurate, n-butyl laurate, i-butyl laurate, n-amyl laurate, n-benzyl laurate, 2-naphthyl laurate, cholesterol laurate, methyl tridecylate, ethyl tridecylate, methyl myristate, ethyl myristate, vinyl myristate, i-propyl myristate, n-butyl myristate, i-butyl myristate, heptyl myristate, n-naphthyl myristate, cholesterol myristate, methyl pentadecylate, ethyl pentadecylate, methyl palmitate, ethyl palmitate, vinyl palmitate, i-propyl palmitate, n-butyl palmitate, i-butyl palmitate, heptyl palmitate, dodecyl palmitate, n-hexadecyl palmitate, methyl heptadecylate, ethyl heptadecylate, cholesterol heptadecylate, methyl stearate, ethyl stearate, vinyl stearate, i-propyl stearate, n-butyl stearate, phenyl stearate, octyl stearate, dodecyl stearate, cholesterol stearate, methyl arachate, methyl behenate, methyl cerotate, methyl melissinate, ethyl behenate, ethyl lignocerate, ethyl montanate, ethyl laccerate, methyl acetylricinoleate, phenyl arachate, phenyl palmitate, glycol myristate, glycol palmitate, glycol stearate, glycerol laurate, glycerol myristate, glycerol palmitate, glycerol stearate, methyl oleate, ethyl oleate, n-butyl oleate, i-butyl oleate, i-amyl oleate, heptyl oleate, oleyl oleate, methyl elaidate, methyl erucate, ethyl erucate and ethyl brassidate.

Other examples of the waxes include petroleum waxes such as paraffin wax, microwax and polyolefin wax (e.g., low-polymerization polyethylene wax, polypropylene wax), natural waxy substances such as carnauba wax, montan wax, microcrystalline wax, beeswax and turpentine. Furthermore, the following organic compounds can also be suitably used.

As a fatty acid amide, examples thereof include acetic acid amide, propionic acid amide, butyric acid amide, valeric acid amide, caproic acid amide, naphthoic acid amide, capric acid amide, caprylic acid amide, undecylic acid amide, lauric acid amide, myristic acid amide, palmitic acid amide, stearic acid amide, behenic acid amide, oleic acid amide, capric acid amide, lauric acid methylamide, myristic acid methylamide, palmitic acid methylamide, stearic acid methylamide, lauric acid dodecylamide, myristic acid dodecylamide, palmitic acid dodecylamide, stearic acid dodecylamide, methylene-bisstearylamide, ethylene-biscaprylamide, ethylene-biscaprylamide, ethylene-bisoleylamide, hexamethylene-bisoleylamide, N,N′-dioleyladipoylamide, N,N′-dioleylsebacoylamide, m-xylylene-bisstearoylamide and N,N′-distearylisophthalylamide.

As a fatty acid anilide, examples thereof include valeric acid anilide, caproic acid anilide, caprylic acid anilide, pelargonic acid amide, capric acid anilide, undecylic acid anilide, lauric acid anilide, myristic acid anilide, palmitic acid anilide, stearic acid anilide and behenic acid anilide.

As aliphatic alcohols, examples thereof include 1-docosanol, stearyl alcohol, arachidin alcohol, behenyl alcohol, carnaubyl alcohol, ceryl alcohol and melissyl alcohol.

As a thioether-base compound, examples thereof include dilauryl thiodipropionate, ditridecyl thiodipropionate, dimyristyl thiodipropionate, dicetyl thiodipropionate, distearyl thiodipropionate, dilauryl thiodibutylate, ditridecyl thiodibutylate, dimyristyl thiodibutylate, dicetyl thiodibutylate, distearyl thiodibutylate, laurylstearyl thiodipropionate, laurylstearyl thiodibutylate, pentaerythritol-β-lauryl thiodipropionate, pentaerythritol-tetrakis(3-laurylthiopropionate), pentaerythritol-tetrakis (3-myristylthiopropionate), pentaerythritol-tetrakis(3-stearylthiopropionate, bis(4-tert-amylphenyl)sulfide, distearyl disulfide, thioethylene glycol-bis (β-aminocrotonate) and 1,4-bis(hydroxynethyl)cyclohexane-thiodipropionate.

As a phthalic acid ester, examples thereof include diethyl phthalate, dibutyl phthalate, dioctyl phthalate, ditridecyl phthalate, dicyclohexyl phthalate, dimethyl isophthalate, diphenyl phthalate and dioctyl tetrahydrophthalate.

As a phosphoric acid ester, examples thereof include trioctyl phosphate and triphenyl phosphate.

Among these waxes, compounds having a linear alkyl group having 10 or more carbon atoms and having one or more ester bond are preferred, and compounds having one or two ester bond are more preferred, because these have an effect of improving the solvent solubility or scratch resistance of a photosensitive material produced and less affect the surface coatability and image-forming property.

Preferred examples of the compound having one ester bond include aliphatic esters such as dodecyl palmitate, dodecyl stearate and heptyl myristate, and preferred examples of the compound having two ester bonds include thioether-base compounds such as dilauryl thiodipropionate, dimyristyl thiodipropionate, distearyl thiodipropionate and laurylstearyl thiodipropionate.

These waxes may be used in combination of two or more thereof. Two or more waxes may be used, but from the standpoint of not complicating the preparation of composition, about 2 to 4 waxes are preferably used in combination.

Which waxes are used in combination can be appropriately selected. For example, a combination of waxes having the same or similar structure and differing in the alkyl chain length, a combination of waxes different in the melting point, or a combination of a wax having a relatively high molecular weight and a wax having a low molecular weight may be used. In view of compatibility, a combination of waxes having a similar structure is preferred. The waxes are preferably selected by also taking account of correlation with other components in the back layer.

The total amount of waxes added is from 0.02 to 10 wt %, preferably from 0.2 to 10 wt %, more preferably from 1 to 10 wt %, based the entire solid content of the back layer. When the amount of these compounds added is 0.02 wt % or more, sufficiently high development stability against external scratching can be obtained, and when the amount added is 10 wt %, the effect is saturated and more addition is not necessary.

In the case of combining two or more waxes, the mixing ratio is, in terms of the ratio of wax added in a smallest amount, preferably 5 wt % or more, more preferably 10 wt % or more, based on all wax components.

The waxes can also be used in combination with the following compound or the like. Examples of the compound or the like which can be used in combination include fatty acids, fatty acid metal salts, low-polymerization polymers and other compounds. Specific examples thereof are described below, but the present invention is not limited thereto.

Examples of the fatty acid include caproic acid, enanthic acid, caprylic acid, pelargonic acid, isopelargonic acid, capric acid, caproleic acid, undecanoic acid, 2-undecenoic acid, 10-undecenoic acid, 10-undecynoic acid, lauric acid, linderic acid, tridecanoic acid, 2-tridecenoic acid, myristic acid, mryristoleic acid, pentadecanoic acid, heptadecanoic acid, behenic acid, palmitic acid, isopalmitic acid, palmitoleic acid, hiragonic acid, hydnocarpic acid, margaric acid, ω-heptadecenoic acid, stearic acid, oleic acid, linoleic acid, linolenic acid, isostearic acid, elaidic acid, petroselinic acid, moroctic acid, eleostearic acid, tariric acid, vaccenic acid, ricinoleic acid, vernolic acid, sterculic acid, nonadecanoic acid, eicosanoic acid, eicosenoic acid, gadolenic acid, arachidonic acid, heneicosanoic acid, docosanoic acid, erucinic acid, brassidic acid, cetoleic acid, clupanodonic acid, tricosanoic acid, 22-tricosenoic acid, lignoceric acid, selacholenoic acid, nisinic acid, pentacosanoic acid, heptacosanoic acid, cerotic acid, montanic acid, melissic acid and lacceric acid.

Examples of the fatty acid metal salt include, silver behenate, lead caproate, lead enanthate, lead caprylate, lead pelargonate, lead caprate, lead laurate, lead Myristate, magnesium palmitate, lead palmitate, lead stearate, lead tridecylate, calcium stearate, aluminum stearate, zinc stearate and magnesium stearate.

Examples of the low-polymerization polymer include low polymerization products such as polyacrylic acid ester, styrene-butadiene copolymerization product, polyvinyl butyral, polyamide and low molecular weight polyethylene.

Other examples include dibenzoic acid, ethylene glycol, diethylene glycol benzoate, epoxy linseed oil, butyl epoxystearate, ethylenephthalylbutyl glycolate, polyester-base plasticizers, nitrile-base synthetic rubber, straight chain dibasic acid esters and oligomers.

The amount of the arbitrary component added is preferably from 3 to 50 wt % based on all waxes. When the amount added is 3 wt % or more, the effect by the addition is obtained, and when 50 wt % or less, deterioration of the film property is not caused.

Other examples of the lubricant include phosphoric acid esters or amino salts of a higher alcohol having from 8 to 22 carbon atoms; palmitic acid, stearic acid, behenic acid, and esters thereof; and silicone-base compounds.

The back layer of the present invention can be formed by adding and mixing (if desired, dispersing) the above-described components directly or a dispersion resulting from dispersing these components in a solvent such as water (if desired, containing a dispersant and a binder), to a water dispersion or aqueous solution containing a binder and appropriate additives to prepare a coating solution for formation of the back layer, and then coating and drying the coating solution.

The back layer of the present invention can be obtained by coating the coating solution for formation of the back layer, on a surface (in the side where the light-to-heat conversion layer and silicone rubber layer are not provided) of the support by a commonly well-known coating method such as dip coating method, air knife coating method, curtain coating method, wire bar coating method, gravure coating method and extrusion coating method.

The back layer of the present invention preferably has a layer thickness of 0.01 to 1 μm, more preferably from 0.1 to 0.5 μm. When the layer thickness is 0.01 μm or more, the coating agent can be uniformly coated with ease and the product has less coating unevenness, and when 1 μm or less, the antistatic property or scratch resistance does not deteriorate.

If desired, the back layer of the present invention may have a layer structure consisting of two or more layers. In the case where the back layer has a layer structure consisting of two or more layers, in the wide sense, all layers of these two or more layers are generically called a back layer and in the narrow sense, a layer in the lower side and a layer thereon may be called a back layer and an overcoat layer, respectively, or the layers may be called a back first layer, a back second layer and the like from the lower side layer. In Examples of the present invention, these layers are called a back first layer, a back second layer and the like.

[Support]

The support for use in the waterless lithographic printing plate precursor of the present invention must be flexible so as to enable setting of the printing plate precursor in a normal press and at the same time, must be durable to the load imposed on printing. Representative examples of the support include coated paper, a metal sheet such as aluminum and aluminum-containing alloy, a plastic film such as polyester (e.g., polyethylene terephthalate, polyethylene-2,6-naphthalate), polyethylene, polypropylene, polystyrene, polyvinyl chloride, polyvinylidene chloride, polyvinyl alcohol, fluororesin, polycarbonate, polyacetate, polyamide and polyimide, a rubber, and a composite material thereof (for example, a composite sheet where paper is sandwiched by aluminum), but the present invention is not limited thereto. The plastic film may be unstretched, monoaxially stretched or biaxially stretched, and a biaxially stretched polyethylene terephthalate film is preferred. For this polyethylene terephthalate film, a film having incorporated therein voids disclosed in JP-A-9-314794 may be used. The thickness of the support for use in the present invention is suitably from 25 μm and 3 μm, preferably from 75 to 500 μm, but the optimum thickness varies depending on the printing conditions. In general, the thickness is most preferably from 100 to 300 μm.

For improving the adhesion and antistatic property on the surface, the support may be subjected to various surface treatments such as corona discharge treatment, adhesion-facilitating treatment by matting, and antistatic treatment. Also, the surface of the support in the side opposite the surface where the light-to-heat conversion layer and silicone rubber layer are stacked may be laminated with a substrate for conventional lithographic printing plate precursors by using an adhesive. Representative examples of this substrate include a metal sheet (e.g., aluminum), an aluminum-containing alloy (for example, an alloy of aluminum with a metal such as silicon, copper, manganese, magnesium, chromium, zinc, lead, bismuth or nickel), a plastic film (e.g., polyethylene terephthalate, polyethylene naphthalate), paper, and a composite sheet laminated with a plastic film such as polyethylene or polypropylene.

[Light-to-Heat Conversion Layer]

The light-to-heat conversion layer for use in the waterless lithographic printing plate precursor of the present invention is a layer having a function of converting the laser ray used for writing, into heat (light-to-heat conversion). Out of known light-to-heat conversion layers having this function and being formed by dissolving or dispersing a light-to-heat converting agent in other components and coating the obtained solution or dispersion, any light-to-heat conversion layer may be used as long as the light-to-heat conversion layer in the part irradiated with a substantially practicable laser partially remains after the plate-making. The amount of the light-to-heat conversion layer remaining after plate-making is preferably 0.01 g/m² or more, more preferably 0.1 g/m² or more, still more preferably 0.2 g/m² or more. If the light-to-heat conversion layer does not remain after plate-making and the support or undercoat layer (described later) which is, if desired, provided, is exposed, this causes deterioration of inking property. Also, in the present invention, when the silicone rubber layer is formed to have a thickness of 2.0 g/m² or more for improving the ink repellency, the weight loss of the light-to-heat conversion layer after plate-making is preferably 0.5 g/m² or more, more preferably 0.6 g/m² or more, so as to enhance the developability in the laser-irradiated part.

The light-to-heat converting agent for use in the present invention may be a known substance having a function of converting the laser ray used for writing, into heat (light-to-heat conversion). In the case of using an infrared laser as the laser light source, it is heretofore known that various organic or inorganic substances of absorbing light at the wavelength used for the laser writing, such as infrared-absorbing pigment, infrared-absorbing dye, infrared-absorbing metal and infrared-absorbing metal oxide, can be used. The light-to-heat converting agent is used in the form of a mixed film with other components such as binder and additives.

Examples of the light-to-heat converting agent include various carbon blacks (e.g., acidic carbon black, basic carbon black, neutral carbon black), various carbon blacks subject to surface modification or surface coating for improving dispersibility, black pigments (e.g., nigrosines, aniline black, cyanine black), phthalocyanine-base or naphthalocyanine-base green pigments, carbon graphite, aluminum, iron powder, diamine-base metal complexes, dithiol-base metal complexes, phenolthiol-base metal complexes., mercaptophenol-base metal complexes, arylaluminum metal salts, crystal water-containing inorganic compounds, copper sulfate, chromium sulfide, silicate compounds, metal oxides (e.g., titanium oxide, vanadium oxide, manganese oxide, iron oxide, cobalt oxide, tungsten oxide, indium tin oxide), and hydroxides and sulfates of these metals. Also, additives such as metal powder of bismuth, tin, tellurium, iron or aluminum are preferably added.

Other examples include, but are not limited to, organic dyes such as various compounds described in Matsuoka, Sekigai Zokan Shikiso (Infrared Sensitizing Dyes), Plenum Press, New York, N.Y. (1990)), U.S. Pat. No. 4,833,124, European Patent 321923, and U.S. Pat. Nos. 4,772,583, 4,942,141, 4,948,776, 4,948,777, 4,948,778, 4,950,639, 4,912,083, 4,952,552 and 5,023,229.

Among these, in view of light-to-heat conversion efficiency, profitability and handleability, carbon black is preferred. The carbon black is classified, by its production process, into furnace black, lamp black, channel black, roll black, disc black, thermal black, acetylene black and the like. In particular, furnace black is preferred because this is commercially inexpensive and various types differing in the particle size and other properties are available on the market. The aggregation degree of primary particles of the carbon black affects the sensitivity of the plate material. If the carbon black has a high aggregation degree of primary particles (having a high-structure constitution), when the amount added is the same, the black chromaticity of the plate material does not increase and the absorbance of laser ray decreases, as a result, the sensitivity becomes low. In addition, this aggregation of particles gives rise to high viscosity or thixotropic property of the coating solution for the light-to-heat conversion layer and in turn, difficult handle-ability of the coating solution or non-uniform coated layer. On the other hand, if the oil absorption of carbon black is low, its dispersibility decreases and the sensitivity of plate material also tends to decrease. The aggregation degree of primary particles of carbon black can be compared by using the value of oil absorption. As the oil absorption is higher, the aggregation degree is higher, and as the oil absorption is lower, the aggregation degree is lower. The carbon black used preferably has an oil absorption of 20 to 300 ml/100 g, more preferably from 50 to 200 ml/100 g.

Carbon black products having various particle sizes are available on the market. The primary particle size also affects the sensitivity of plate material. If the average primary particle size is too small, the light-to-heat conversion layer itself tends to be transparent and cannot efficiently absorb the laser ray and this causes low sensitivity of the plate material. On the other hand, if the average primary particle size is excessively large, the particles cannot be dispersed to a high density and the light-to-heat conversion layer cannot have a high black chromaticity and therefore, cannot efficiently absorb the laser ray, as a result, the sensitivity of plate material also decreases. The carbon black used preferably has an average particle size of, in terms of the primary particle size, from 10 and 50 nm, more preferably from 15 to 45 nm. Also, by using an electrically conducting carbon black, the sensitivity of the plate material can be elevated. At this time, the electric conductivity is preferably from 0.01 to 100 Ω⁻¹ cm⁻¹, more preferably from 0.1 to 10 Ω⁻¹ cm⁻¹. Specific preferred examples of this carbon black include “Conductex” 40-220, “Conductex” 975 Beads, “Conductex” 900 Beads, “Conductex” SC and “Battery Black” (produced by Colombian Carbon Japan), #3000 (produced by Mitsubishi Chemical Corporation), “Denkablack” (produced by Electro Chemical Industry Co., Ltd.), and “Vulcan XC-72R” (produced by Cabbot). The amount of the light-to-heat converting agent added in the light-to-heat conversion layer for use in the present invention is from 1 to 70 wt %, preferably from 5 to 50 wt %, based on the entire composition of light-to-heat conversion layer when the amount added is 1 wt % or more, the sensitivity of the plate material does not decrease, and when the amount added is 70 wt % or less, the film strength of the light-to-heat conversion layer does not decrease and also, the adhesion to the adjacent layer does not decrease.

In the case where the light-to-heat conversion layer is a single film, a film containing at least one of metals such as aluminum, titanium, tellurium, chromium, tin, indium, bismuth, zinc and lead, their alloys, metal oxides, metal carbides, metal nitrides, metal borides and metal fluorides, and organic dyes can be formed on a support by vapor deposition or sputtering.

In the case where the light-to-heat conversion layer is a mixed film, this can be formed by dissolving or dispersing a light-to-heat converting agent in a binder and coating it together with other components. For this binder, a known binder capable of dissolving or dispersing the light-to-heat converting agent is used and examples thereof include cellulose; cellulose derivatives such as nitrocellulose and ethyl cellulose; homopolymers and copolymers of acrylic acid ester; homopolymers and copolymers of methacrylic acid ester such as polymethyl methacrylate and polybutyl methacrylate; homopolymers and copolymers of styrene-base monomer such as polystyrene and α-methylstytene; various synthetic rubbers such as polyisoprene and styrene-butadiene copolymer; homopolymers of vinyl esters such as polyvinyl acetate; vinyl ester-containing copolymers such as vinyl acetate-vinyl chloride copolymer; various condensation polymers such as polyurea, polyurethane, polyester and polycarbonate; and binders for use in a so-called “chemical amplification system” described in Frechet, et al., J. Imaging Sci., pp. 59-64, 30 (2) (1986), Ito and Willson, Polymers in Electronics Symposium Series, p. 11, 242, edited by T. Davidson, ACS Washington, D.C. (1984), and E. Reichmanis and L. F. Thompson, Microelectronic Engineering, pp. 3-10, 13 (1991).

Among these, polyurethane resin is preferred in view of adhesion to the silicon rubber layer (which is described later) or the undercoat layer (which is described later) provided, if desired. The polyurethane resin can be obtained by the poly-addition of a diisocyanate compound and a diol compound. Examples of the diisocyanate compound include aromatic diisocyanate compounds such as 2,4-tolylene diisocyanate, 2,4-tolylene diisocyanate dimer, 2,6-tolylene diisocyanate, p-xylylene diisocyanate, m-xylylene diisocyanate, 4,4′-diphenylmethane diisocyanate, 4,4′-(2,2-diphenylpropane) diisocyanate, 1,5-naphthylene diisocyanate and 3,3′-dimethylbiphenyl-4,4′-diisocyanate; aliphatic diisocyanate compounds such as hexamethylene diisocyanate, trimethylhexamethylene diisocyanate, lysine diisocyanate and dimeric acid diisocyanate; alicyclic diisocyanate compounds such as isophorone diisocyanate, 4,4′-methylenebis(cyclohexylisocyanate), methylcyclohexane-2,4 (or 2,6)-diisocyanate and 1,3-(isocyanatomethyl) cyclohexane; and diisocyanate compounds which are a reaction product of a diol and a diisocyanate, such as adduct of 1 mol of 1,3-butylene glycol and 2 mol of tolylene diisocyanate.

Examples of the diol compound include ethylene glycol, diethylene glycol, triethylene glycol, tetraethylene glycol, polyethylene glycol, propylene glycol, 1,2-dipropylene glycol, 1,2-tripropylene glycol, 1,2-tetrapropylene glycol, 1,3-dipropylene glycol, polypropylene glycol, 1,3-butylene glycol, 1,3-dibutylene glycol, neopentyl glycol, 1,6-hexanediol, 2-butene-1,4-diol, 2,2,4-trimethyl-1,3-pentanediol, 1,4-bis-β-hydroxyethoxycyclohexane, cyclohexanedimethanol, tricyclodecanedimethanol, bisphenol A, hydrogenated bisphenol A, hydrogenated bisphenol F, bisphenol S, hydroquinone dihydroxyethyl ether, p-xylylene glycol, dihydroxyethylsulfone, 2,2′-dimethylolpropanoic acid, bis(2-hydroxyethyl)-2,4-tolylene dicarbamate, 2,4-tolylene-bis(2-hydroxyethylcarbamide), bis(2-hydroxyethyl)-m-xylylene dicarbamate and bis(2-hydroxyethyl) isophthalate. Other examples include polyethers obtained by the condensation of those diol compounds, and polyester diols obtained by the condensation of a dicarboxylic acid compound (e.g., adipic acid, terephthalic acid) with the above-described diol compound. At the synthesis of these polyurethane resins, a chain linking agent such as diamine compound, hydrazine and hydrazine derivative may be used.

In the case of forming the light-to-heat conversion layer as a mixed film, various additives may be added to the light-to-heat conversion layer for various purposes, for example, for increasing the mechanical strength of the light-to-heat conversion layer, improving the sensitivity to laser recording, improving the dispersibility of light-to-heat converting agent or the like in the light-to-heat conversion layer, or improving the adhesion to a layer adjacent to the light-to-heat conversion layer, such as undercoat layer, interlayer and silicone rubber layer which are described later.

For example, various crosslinking agents of curing the light-to-heat conversion layer may added for increasing the mechanical strength of the light-to-heat conversion layer. Examples of the crosslinking agent include, but are not limited to, combinations of a polyfunctional isocyanate compound or polyfunctional epoxy compound with a hydroxyl group-containing compound, carboxylic acid compound, thiol-base compound, amine-base compound or urea-base compound. The amount added of the crosslinking agent for use in the present invention is from 1 to 50 wt %, preferably from 2 to 20 wt %, based on the entire composition of light-to-heat conversion layer. When the amount added is 1 wt % or more, the effect of crosslinking is brought out, and when 50 wt % or less, the film strength of the light-to-heat conversion layer does not become excessively high and the shock absorber effect against external pressure on the silicone rubber layer is not lost, as a result, the scratch resistance does not decrease.

Also, a known compound of decomposing under heat and generating a gas may be added for improving the laser-recording sensitivity. In this case, the laser-recording sensitivity can be increased by the abrupt volume expansion of the light-to-heat conversion layer. Examples of this additive which can be used include dinitropentamethylene-tetramine, N,N′-dimethyl-N,N′-dinitrosoterephthalamide, p-toluenesulfonylhydrazide, 4,4-oxybis(benzensulfonyl-hydrazide) and diamidobenzene. Furthermore, for improving the laser-recording sensitivity, a compound known as a thermal acid generator of decomposing under heat to generate an acidic compound may be used as the additive and examples of this additive include various iodonium salts, sulfonium salts, phosphonium tosylates, oxime sulfonates, dicarbodiimidosulfonates and triazines. By using such a compound in combination a chemical amplification-type binder, the decomposition temperature of the chemical 40amplification-type binder as a constituent substance of the light-to-heat conversion layer can be greatly decreased and thereby the laser-recording sensitivity can be increased. In the case of using a pigment such as carbon black for the light-to-heat converting agent, various pigment dispersants can be used as an additive for improving the dispersibility of the pigment.

The amount added of the pigment dispersant for use in the present invention is from 1 to 70 wt %, preferably from 5 to 50 wt %, based on the light-to-heat converting agent. When the amount added is 1 wt % or more, the effect of improving the dispersibility of pigment is brought out and the sensitivity of the plate material does not decrease, and when 70 wt % or less, the adhesion to an adjacent layer does not decrease. For improving the adhesion to an adjacent layer, a known adhesion improver such as silane coupling agent and titanate coupling agent, or a binder having good adhesive property to an adjacent layer, such as vinyl group-containing acrylate-base resin, hydroxyl group-containing acrylate-base resin, acrylamide-base resin, ethylene-vinyl acetate copolymer, vinyl chloride-vinyl acetate copolymer, cellulose derivative and gelatin, may be added. The amount added of the adhesion improver or adhesion-improving binder for use in the present invention is from 5 to 70 wt %, preferably from 10 to 50 wt %, based on the entire composition of light-to-heat conversion layer. When the amount added is 5 wt % or more, the effect of improving the adhesion to an adjacent layer is brought out, and when 70 wt % or less, the sensitivity of the plate material does not decrease.

For improving the coatability, a surfactant such as fluorine-containing surfactant and nonionic surfactant may be used as an additive. The amount added of the surfactant for use in the present invention is from 0.01 to 10 wt %, preferably from 0.05 to 1 wt %, based on the entire composition of light-to-heat conversion layer. When the amount added is 0.01 wt % or more, good coatability is obtained and uniform formation of the light-to-heat conversion layer is facilitated, and when 10 wt % or less, the adhesion to an adjacent layer does not decrease. Other than these, various additives can be used, if desired.

The thickness of the light-to-heat conversion layer for use in the present invention is from 0.05 to 10 μm², preferably from 0.1 to 5 g/m². If the thickness of the light-to-heat conversion layer is too small, a sufficiently high optical density cannot be obtained and the laser-recording sensitivity decreases, as a result, the uniform film formation becomes difficult and the image quality deteriorates. On the other hand, if the layer thickness is excessively large, this is not preferred in view of reduction of laser-recording sensitivity and increase of production cost. The light-to-heat conversion layer for use in the present invention can be formed by applying and then drying the coating solution for formation of the light-to-heat conversion layer on a support or on the surface of an undercoat layer (which is described later) formed, if desired. In applying the coating solution, a commonly well-known coating method may be used, such as dip coating, air knife coating, curtain coating, wire bar coating, gravure coating and extrusion coating.

[Silicon Rubber Layer]

The ink-repellent silicone rubber layer for use in the present invention is formed by forming a silicone rubber film on the light-to-heat conversion layer through a reaction. More specifically, the silicone rubber layer is preferably formed by curing a condensation-type silicone with a crosslinking agent or by addition-polymerizing an addition-type silicone in the presence of a catalyst. In the case of using a condensation-type silicone, a composition obtained by adding (b) from 3 to 70 parts by weight of a condensation-type crosslinking agent and (c) from 0.01 to 40 parts by weight of a catalyst, per (a) 100 parts by weight of diorganopolysiloxane is preferably used. The diorganopolysiloxane as the component (a) is a polymer having a repeating unit represented by the formula shown below. In the formula, R¹ and R² each represents an alkyl group having from 1 to 10 carbon atoms, a vinyl group or an aryl group and each may have other appropriate substituents. In general, a polymer where 60% or more of R¹ and R² are a methyl group, a vinyl halide group or a phenyl halide group is preferred.

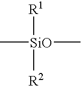

This diorganopolysiloxane preferably has a hydroxyl group at both terminals. The number average molecular weight of the component (a) is from 3,000 to 600,000, preferably from 5,000 to 100,000. The crosslinking agent as the component (b) may be any crosslinking agent as long as it is a condensation type, but is preferably a crosslinking agent represented by the following formula:

R¹ₘ.Si.Xₙ

(wherein m+n=4 and n is 2 or more).

In this formula, R¹ has the same meaning as R¹ above and X represents a halogen atom (e.g., Cl, Br, I), a hydrogen atom, a hydroxyl group or an organic substituent shown below:

—OCOR³, —OR³,

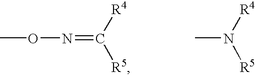

wherein R³ represents an alkyl group having from 1 to 10 carbon atoms or an aryl group having from 6 to 20 carbon atoms, and R⁴ and R⁵ each represents an alkyl group having from 1 to 10 carbon atoms.

Examples of the component (a) include known catalysts such as metal carboxylate with tin, zinc, lead, calcium, manganese or the like (e.g., dibutyl laurate, lead octylate, lead naphthenate), and chloroplatinic acid. In the case of using an addition-type silicone, a composition obtained by adding (e) from 0.1 to 25 parts by weight of an organo-hydrogenpolysiloxane and (f) from 0.00001 to 1 part by weight of a catalyst for addition reaction per (d) 100 parts by weight of a diorganopolysiloxane having an addition-reactive functional group is preferably used. The diorganopolysiloxane having an addition-reactive functional group, as the component (d), is an organopolysiloxane having, within one molecule, at least two alkenyl groups (preferably vinyl groups) directly bonded to the silicon atom, where the alkenyl groups may be present at terminals of molecule or in the midstream thereof and in addition to the alkenyl groups, an organic group such as substituted or unsubstituted alkyl or aryl group having from 1 to 10 carbon atoms may be contained. Furthermore, the component (d) may have arbitrarily a trace amount of hydroxyl group. The number average molecular weight of the component (d) is from 3,000 to 600,000, preferably from 5,000 to 150,000.

Examples of the component (e) include a polydimethylsiloxane having a hydrogen group at both terminals, an α,ω-dimethylpolysiloxane, a methylsiloxane/dimethylsiloxane copolymer having a methyl group at both terminals, a cyclic polymethylsiloxane, a polymethylsiloxane having a trimethylsilyl group at both terminals, and a dimethylsiloxane/methylsiloxane copolymer having a trimethylsilyl group at both terminals. The component (f) is arbitrarily selected from known polymerization catalysts but is preferably a platinum compound and examples thereof include simple platinum, platinum chloride, chloroplatinic acid, and olefin-coordinated platinum.

In these compositions, for controlling the curing rate of the silicone rubber layer, a crosslinking inhibitor may be added, such as vinyl group-containing organopolysiloxane (e.g., tetracyclo(methylvinyl)siloxane), and a carbon-carbon triple bond-containing alcohol, acetone, methyl ethyl ketone, methanol, ethanol or propylene glycol monomethyl ether. The silicone rubber layer (D) for use in the present invention can be formed by coating a composition containing the above-described silicone and prepared by using a solvent on the light-to-heat conversion layer (C) and then drying it. Here, at the time of drying the solvent after the coating solution for formation of the silicone rubber layer is coated, the silicon rubber layer composition undergoes a condensation or addition reaction and thereby a film is formed. Therefore, if the drying temperature is low, the curing property of silicone rubber may decrease to cause curing failure. In this respect, the drying temperature after coating of the silicone rubber layer is preferably 80° C. ore more, more preferably 100° C. or more.

In the silicone rubber layer, if desired, a fine inorganic powder such as silica, calcium carbonate and titanium oxide, an adhesion aid such as silane coupling agent, titanate coupling agent and aluminum coupling agent, and a photopolymerization initiator may be added. The thickness of the silicone rubber layer for use in the present invention is preferably, in terms of the dry thickness, from 0.5 to 5.0 g/m², more preferably from 1.0 to 3.0 g/m², still more preferably from 2.0 to 2.5 g/m². When the thickness is 0.5 g/m² or more, the ink repellency does not decrease and the problem of easy scratching or the like can be overcome, and when 5.0 g/m² or less, the developability is not worsened. On the silicone rubber layer, a surface layer may be formed by further coating various silicone rubber layers for the purpose of enhancing the press life, scratch resistance, image reproducibility and scumming resistance.

[Other Layers]

In the waterless lithographic printing plate precursor of the present invention, other layers may be provided according to the purpose in addition to the above-described layer constitution as long as the effect of the present invention is not, impaired. Other layers are described below.

(Undercoat Layer)

In the waterless lithographic printing plate precursor of the present invention, an undercoat layer is preferably provided between the support and the light-to-heat conversion layer, and the undercoat layer is formed by aqueous coating of a water-soluble or water-dispersible polymer-containing coating solution. This undercoat layer is useful as an adhesive layer between the support and the light-to-heat conversion layer, and also plays a role of the cushion layer for relieving the pressure to the silicon rubber layer on printing. The composition therefor contains, as the binder, a water-soluble polymer or a water-dispersible polymer usable in the state of water dispersion such as emulsion, or both of these polymers. In order to form a uniform layer by aqueous coating, the components other than the binder, such as various additives, must also be a water-soluble material or a material usable in the state of water dispersion such as emulsion. An aqueous solution or water dispersion containing these materials is prepared as the coating solution for forming the undercoat layer and this is coated and dried to form the undercoat layer for use in the present invention.

The constituent components of the undercoat layer are described below.

Binder:

Examples of the binder for use in the undercoat layer include proteins such as gelatin and casein, cellulose compounds such as carboxymethyl cellulose, hydroxyethyl cellulose, acetyl cellulose, diacetyl cellulose and triacetyl cellulose, saccharides such as dextran, agar, sodium alginate and starch derivative, and synthetic polymers such as polyvinyl alcohol, polyvinyl acetate, polyacrylic acid ester, polymethacrylic acid ester, polystyrene, polyacrylamide, poly-N-vinylpyrrolidone, polyester, polyurethane, polyvinyl chloride and polyacrylic acid. Also, in view of adhesion between the support and the undercoat layer and blocking at the production, the undercoat layer for use in the present invention preferably has a crosslinked structure. The crosslinked structure may be formed, for example, by a method of using a binder having a crosslinkable group capable of reacting with a crosslinking agent and forming the crosslinked structure through a reaction with the crosslinking agent, however, the present invention is not limited thereto. In the case of forming the crosslinked structure by the above-described method, the binder used preferably has, as the cross-linkable group, any one of a methylol group, a hydroxyl group, a carboxyl group and a glycidyl group.

Crosslinking Agent:

Examples of the crosslinking agent added when the crosslinked structure is formed by the above-described method include those described in C. E. K. Meers and T. H. James, The Theory of Photographic Process, 3rd ed. (1966), U.S. Pat. Nos. 3,316,095, 3,232,764, 3,288,775, 2,732,303, 3,635,718, 3,232,763, 2,732,316, 2,586,168, 3,103,431, 3,017,280, 2,983,611, 2,725,294, 2,725,295, 3,100,704, 3,091,537, 3,321,313, 3,543,292 and 3,125,449, and British Patents 994,869 and 1,167,207. Representative examples thereof include melamine compounds, aldehyde-base compounds and derivatives thereof, active vinyl-base compounds, active halogen-base compounds and epoxy compounds.

Examples of the melamine compound include compounds having two or more (preferably three or more) methylol groups and/or alkoxymethyl groups within the melamine molecule, and condensation polymers thereof such as melamine resin and melamine/urea resin. Examples of the initial condensate of melamine and formalin include dimethylolmelamine, trimethylolmelamine, tetramethylolmelamine, pentamethylolmelamine and hexamethylolmelamine. Specific examples of the commercially available product thereof include, but are not limited to, Sumitex Resin M-3, MW, MK and MC (produced by Sumitomo Chemical Co., Ltd.). Examples of the condensation polymer include hexamethylolmelamine resin, trimethylolmelamine resin and trimethyloltrimethoxymethylmelamine resin. Examples of the commercially available product thereof include, but are not limited to, MA-1 and MA-204 (produced by Sumitomo Bakelite Co. Ltd.), Beckamine MA-S, Beckamine APM and Beckamine J-101 (produced by Dai-Nippon Ink & Chemicals, Inc.), Euroid 344 (produced by Mitsui Toatsu Chemicals Inc.), Ohka Resin M31 and Ohka Resin PWP-8 (produced by Ohka Shinko K.K.).

The melamine compound for use in the present invention preferably has a functional equivalent of 50 to 300 as expressed by a value obtained by dividing the molecular weight by the number of functional groups within one molecule. The functional group here indicates a methylol group or an alkoxymethyl group. With a functional equivalent of 300 or less, an appropriate curing density and high strength can be obtained, and with a functional equivalent of 50 or more, the curing density is not high and the properties of the coating solution are improved without impairing the aging stability. The amount added of the melamine compound for use in the present invention is from 0.1 and 100 wt %, preferably from 10 and 90 wt %, based on the above-described binder.

Representative specific examples of the aldehyde-base compound and its derivative include mucochloric acid, mucobromic acid, mucophenoxychloric acid, mucophenoxybromic acid, formaldehyde, glyoxal, monomethylglyoxal, 2,3-dihydroxy-1,4-dioxane, 2,3-dihydroxy-5-methyl-1,4-dioxane succinaldehyde, 2,5-dimethoxytetrahydrofuran and glutaraldehyde. Representative specific examples of the active vinyl-base compound include divinylsulfone-N,N′-ethylenebis(vinylsulfonylacetamide), 1,3-bis(vinylsulfonyl)-2-propanol, methylenebismaleimide, 5-acetyl-1,3-diacryloylhexahydro-s-triazine, 1,3,5-triacryloylhexahydro-s-triazine and 1,3,5-trivinylsulfonylhexahydro-s-triazine.

Representative specific examples of the active halogen-base compound include 2,4-dichloro-6-hydroxy-s-triazine sodium salt, 2,4-dichloro-6-(4-sulfoanilino)-s-triazine sodium salt, 2,4-dichloro-6-(2-sulfoethylamino)-s-triazine and N,N-bis(2-chloroethylcarbamyl)piperazine. Representative specific examples of the epoxy compound include bis(2,3-epoxypropyl)methylpropylammonium p-52-toluenesulfonate, 1,4-bis(2′,3′-epoxypropyloxy)butane, 1,3,5-triglycidyl isocyanurate, 1,3-glycidyl-5-(y-acetoxy-β-oxypropyl) isocyanurate, sorbitol polyglycidyl ethers, polyglycerol polyglycidyl ethers, pentaerythritol polyglycidyl ethers, diglycerol polyglycidyl ether, 1,3,5-triglycidyl (2-hydroxyethyl) isocyanurate, glycerol polyglycerol ethers and trimethylolpropane polyglycidyl ethers.

Other examples include ethyleneimine-base compounds such as 2,4,6-triethylene-s-triazine, 1,6-hexamethylene-N,N′-bisethyleneurea and bis-α-ethyleneiminoethylthioether; methanesulfonic acid ester-base compounds such as 1,2-di(methanesulfonoxy)ethane, 1,4-di(methanesulfonoxy)butane and 1,5-(methanesulfonoxy)pentane; carbodiimide compounds such as dicyclohexylcarbodiimide and 1-dicyclohexyl-3-(3-trimethylaminopropyl)carbodiimide hydrochloride; isoxazole compounds such as 2,5-dimethylisoxazole; inorganic compounds such as chromium alum and chromium acetate; dehydrating condensation-type peptide reagents such as N-carboethoxy-2-isopropoxy-1,2-dihydroquinoline and N-(1-morpholinocarboxy)-4-methylpyridinium chloride; active ester-base compounds such as N,N′-adipoyldioxydisuccinimide and N,N′-terephthaloyldioxydisuccinimide; isocyanates such as toluene-2,4-diisocyanate and 1,6-hexamethylene-diisocyanate; and epichlorohydrin-base compounds such as polyamide-polyamine-epichlorohydrin reaction product. However, the present invention is not limited thereto.

Metal oxide Particle:

From the standpoint of improving the adhesion between the support and the undercoat layer, imparting antistatic property and preventing occurrence of blocking at the production, a metal oxide particle is preferably added to the undercoat layer for use in the present invention. Examples of the material for the metal oxide particle include ZnO, SnO₂, Al₂O₃, In₂O₃, MgO, BaO, MoO₃, V₂O₅, a composite oxide thereof, and a metal oxide when the above-described metal oxide further contains a heteroatom. These metal oxide particles may be used individually or as a mixture. The metal oxide is preferably ZnO, SnO₂, Al₂O₃, In₂O₃ or MgO, more preferably ZnO, SnO₂ or In₂O₃, still more preferably SnO₂. Examples of the metal oxide containing a small amount of heteroatom include those obtained by doping 30 mol % or less, preferably 10 molt or less, of a heteroatom such as Al or In to ZnO, Sb, Nb or halogen atom to SnO₂, or Sn to In₂O₃. When the amount of the heteroatom doped is 30 molt or less, the adhesion between the support and the undercoat layer is enhanced.

The metal oxide particle is contained in an amount of 10 to 1,000 wt %, preferably from 100 to 800 wt %, based on the binder of the undercoat layer. When the content is 10 wt % or more, a sufficiently high adhesive property can be obtained between the support and the undercoat layer, and when 1,000 wt % or less, the metal oxide particle can be prevented from falling from the undercoat layer. The particle size of the metal oxide particle is, in terms of the average particle size, from 0.001 to 0.5 μm, preferably from 0.003 to 0.2 μm. When the average particle size is 0.001 μm or more, a sufficiently high adhesive property can be obtained between the support and the undercoat layer, and when 0.5 μm or less, the metal oxide particle can be prevented from falling from the undercoat layer. Thus, these are both proper. The average particle size as used herein is a value including not only the primary particle size of the metal oxide particle but also the particle size of higher order structures.

Additives (Additives of Undercoat Layer):

In the undercoat layer for use in the present invention, various additives may be used in addition to the binder and the crosslinking agent and metal oxide particle which are added, if desired. These additives are added according to various purposes, for example, for improving the adhesion to an adjacent layer such as light-to-heat conversion layer and support, preventing occurrence of blocking at the production, improving the dispersibility of metal oxide particles in the undercoat layer, or improving the coatability. Examples thereof include a blend binder, an adhesion aid, a matting agent, a surfactant and a dye. Examples of the blend binder which can be used include polymers such as polyvinyl alcohol, modified polyvinyl alcohol, polyvinylpyrrolidone, polyurethane, polyamide, styrene-butadiene rubber, carboxy-modified styrene-butadiene rubber, acrylonitrile-butadiene rubber, carboxy-modified acrylonitrile-butadiene rubber, polyisoprene, acrylate rubber, polyethylene, chlorinated polyethylene, chlorinated polypropylene, vinyl chloride-vinyl acetate copolymer, nitrocellulose, halogenated polyhydroxystyrene and chloride rubber. The blend binder may be added in an arbitrary ratio and if the ratio is in the range capable of forming a film layer, the undercoat layer may be formed only by the blend binder.

Examples of the adhesion aid include a polymerizable monomer, a diazo resin, a silane coupling agent, a titanate coupling agent and an aluminum coupling agent. Examples of the matting agent include an inorganic or organic particle having an average particle size of preferably from 0.5 to 20 μm, more preferably from 1.0 to 15 μm. In particular, a crosslinked particle of polymethyl methacrylate, polystyrene, polyolefin or a copolymer thereof is preferred. Generally, the thickness of the undercoat layer is, in terms of the dry thickness, preferably from 0.01 to 10 μm, more preferably from 0.1 to 5 μm When the thickness is 0.01 pa or more, the coating agent can be uniformly coated with ease and the product can be free from uneven coating, and when 10 μm or less, this is advantageous from the economical viewpoint.

[Interlayer]

In the present invention, an interlayer formed by aqueous coating may be provided between the undercoat layer and the light-to-heat conversion layer. The interlayer is provided mainly for assisting the function of preventing the metal oxide particle in the undercoat layer from falling at the production and for improving the slipperiness and scratch resistance at the production.

Binder:

The binder which can be used for the interlayer may be the same as that for the undercoat layer. Other examples include waxes, resins and rubber-like materials, each comprising a homopolymer or copolymer of 1-olefin type unsaturated hydrocarbon (e.g., ethylene, propylene, 1-butene, 4-methyl-1-pentene), such as polyethylene, polypropylene, poly-1-butene, poly-4-methyl-1-pentene, ethylene/propylene copolymer, ethylene/1-butene copolymer and propylene/1-butene copolymer; rubber-like copolymers of two or more of the above-described 1-olefins with a conjugated or non-conjugated diene, such as ethylene/propylene/ethylidenenorbornene copolymer, ethylene/propylene/1,5-hexadiene copolymer and isobutene/isoprene copolymer; copolymers of 1-olefin with a conjugated or non-conjugated diene, such as ethylene/butadiene copolymer and ethylene/ethylidene-norbornene copolymer; copolymers of a 1-olefin, particularly ethylene, with vinyl acetate, or completely or partially saponified products thereof; and graft polymers obtained by grafting the above-described conjugated or non-conjugated diene, vinyl acetate or the like to a 1-olefin homopolymer or copolymer, or completely or partially saponified products thereof. The binder of the interlayer for use in the present invention must be a water-soluble binder or a binder usable in the state of water dispersion such as emulsion. In this respect, a polymer latex of acrylic resin, vinyl resin, polyurethane resin or polyester resin, and a water-soluble polyolefin resin are preferred.

Additives (Additives of Interlayer):

Similarly to the undercoat layer, various additives such as matting agent and surfactant can be used also in the interlayer for use in the present invention. The thickness of the interlayer for use in the present invention is preferably from 0.01 to 1 μm, more preferably from 0.01 to 0.2 μm. When the thickness is 0.01 μm or more, the coating agent can be uniformly coated with ease and the product can be free from uneven coating, and when 1 μm or less, this is advantageous from the economical viewpoint.

[Plate-Making Method]

The plate-making method for producing a lithographic printing plate from the waterless lithographic printing plate precursor of the present invention is described below. Similarly to the general plate-making method, the plate-making process comprises an exposure step of imagewise exposing the lithographic printing plate precursor to decrease the adhesive property of the silicone rubber layer to the adjacent layer in the exposed area, and a development step of removing the silicone rubber layer decreased in the adhesive property to form an ink-receiving region.

(I) Exposure Step

In the plate-making method for producing a lithographic printing plate from the waterless lithographic printing plate precursor of the present invention, it is important as described above that a part of the light-to-heat conversion layer in the laser-irradiated part remains after plate-making. Therefore, the laser used for exposing the waterless lithographic printing plate precursor must give an exposure intensity of bringing about reduction in the adhesive strength large enough to cause separation and removal of the silicone rubber layer; and at the same time, allowing the light-to-heat conversion layer in the laser-irradiated part to remain after plate-making. The residual amount of the light-to-heat conversion layer can be easily controlled by adjusting the laser output according to the composition and thickness of the light-to-heat conversion layer or by adjusting the main scanning rate (writing rate) of the laser. As long as these conditions are satisfied, the laser species is not particularly limited and for example, a gas laser such as Ar laser and carbonic acid gas laser, a solid laser such as YAG laser, or a semiconductor laser can be used. Usually, a laser output of 50 mW or more is necessary. From practical aspects such as maintenance and cost, a semiconductor laser or a semiconductor-excited solid laser (e.g., YAG laser) is suitably used. The recording wavelength of these lasers is present in the infrared wavelength region and an oscillation wavelength from 800 to 1,100 nm is used in many cases. The exposure can also be performed by using an imaging device described in JP-A-6-186750 or a full-color printing system “Quickmaster DI46-4” (trade name) manufactured by Heidelberg, but in this case, it is still important to control the residual amount of the light-to-heat conversion layer by adjusting the irradiation output or scanning rate of the laser according to the thickness of the light-to-heat conversion layer.

(II) Developing Step

The developer for use in the plate-making process of a lithographic printing plate from the waterless lithographic printing plate precursor of the present invention may be a developer known as the developer for waterless lithographic printing plate precursors, such as hydrocarbons, polar solvents, water and a combination thereof, but in view of safety, water or an aqueous solution mainly comprising water and containing an organic solvent is preferably used. When the safety, inflammability and the like are taken into account, the concentration of the organic solvent is preferably less than 40 wt %. Examples of the hydrocarbons which can be used include aliphatic hydrocarbons [specifically, for example, hexane, heptane, gasoline, kerosene and other commercially available solvents such as “Isoper E, H, G” (produced by Esso Kagaku)], aromatic hydrocarbons (e.g., toluene, xylene), and halogenated hydrocarbons (e.g., trichlene). Examples of the polar solvent include alcohols (specifically, for example, methanol, ethanol, propanol, isopropanol, benzyl alcohol, ethylene glycol monomethyl ether, 2-ethoxyethanol, diethylene glycol monomethyl ether, diethylene glycol monohexyl ether, triethylene glycol monomethyl ether, propylene glycol monoethyl ether, dipropylene glycol monomethyl ether, polyethylene glycol monomethyl ether, polypropylene glycol and tetraethylene glycol), ketones (e.g., acetone, methyl ethyl ketone), esters (e.g., ethyl acetate, methyl lactate, butyl lactate, propylene glycol monomethyl ether acetate, diethylene glycol acetate, diethyl phthalate), triethyl phosphate and tricresyl phosphate. Also, water itself such as tap water, pure water or distilled water may also be used alone. These solvents may be used individually or in combination of two or more, for example, by adding water to a hydrocarbon or to a polar solvent or by combining a hydrocarbon and a polar solvent. Among these hydrocarbons and polar solvents, those having low affinity for water may be increased in the solubility in water by adding a surfactant or the like. Also, together with the surfactant, an alkali agent (e.g., sodium carbonate, diethanolamine, sodium hydroxide) may be added.

The development may be performed by a known method, for example, by rubbing the plate surface with a developing pad containing the above-described developer or by pouring the developer on the plate surface and then rubbing the plate surface with a developing brush in water. The developer temperature may be an arbitrary temperature but is preferably from 10 to 50° C. By this development, the silicone rubber layer as the ink-repellent layer of the image area is removed and this portion works out to an ink-receiving part. This development and subsequent treatments of water washing and drying may be performed in an automatic processing machine. A preferred example of the automatic processing machine is described in JP-A-2-220061. Furthermore, by using the above-described full-color printing system “Quickmaster DI46-4” manufactured by Heidelberg, exposure and on-press development can be continuously performed under suitable conditions.

The waterless lithographic printing plate precursor of the present invention can also be developed by laminating an adhesive layer to the surface of the silicone rubber layer and then peeling off the adhesive layer. The adhesive layer may be any known adhesive capable of closely contacting with the surface of the silicone rubber layer. For example, an adhesive layer provided on a flexible support is commercially available under the trade name of “SCOTCH TAPE #85Al” from Sumitomo 3M.

In the case of storing thus-processed and produced lithographic printing plates in the piled state, an interleaf paper is preferably inserted between plates so as to protect the printing plate. The lithographic printing plate produced by this plate-making method is loaded on a press and can give many sheets of a good printed matter with excellent inking property in the image area.

### EXAMPLES

The present invention is described in greater detail below by referring to Examples, however, the present invention is not limited to the following Examples.

### Examples 1 to 19 and Comparative Examples 1 to 8

(Formation of Back First Layer)

On a 188 μm-thick polyester film “E-5101” (produced by Toyobo Co., Ltd.) of which surface was subjected to a corona discharge treatment, the following coating solution was coated by a wire bar coating method and dried at 180° C. for 30 seconds to form a back first layer having a dry thickness of 0.2 μm.

<Coating Solution for Back First Layer>

| | |
|---|---|
| JULIMER ET-410 (water | 1.9 parts by weight |
| dispersion of acrylic resin, | |
| produced by Nihon Junyaku Co., | |
| Ltd., solid content: 30 wt %) | |
| Electrically conducting | 9.1 parts by weight |
| particle (water dispersion of | |
| tin oxide-antimony oxide, | |
| average particle size: shown | |
| in Table 1, 17 wt %) | |
| DENACOLE EX-614B (epoxy | 0.18 parts by weight |
| compound, produced by Nagase | |
| Chemtex, effective component | |
| concentration: 100 wt %) | |
| SANDED BL (aqueous sodium | 0.14 parts by weight |
| alkylsulfonate solution, | |
| produced by Sanyo Chemical | |
| Industries Co., Ltd., 44 wt %) | |
| EMALEX 710 (polyoxyethylene | 0.06 parts by weight |
| alkyl ether, produced by Nihon | |
| Emulsion Co., Ltd., 100 wt %) | |
| Distilled water | 89 parts by weight |

(Formation of Back Second Layer)

On the back first layer formed above, the following coating solution was coated by a wire bar coating method and dried at 170° C. for 30 seconds to form a back second layer having a dry thickness of 0.07 μm.

<Coating Solution for Back Second Layer>

| | |
|---|---|
| CHEMIPEARL S-120 (polyolefin- | 1.6 parts by weight |
| base latex, produced by Mitsui | |
| Chemicals, Inc., solid | |
| content: 27 wt %) | |
| SNOWTEX C (colloidal silica, | 1.1 parts by weight |
| produced by Nissan Chemicals | |
| Industries, Ltd., solid | |
| content: 20 wt %) | |
| SANDED BL (aqueous sodium | 0.12 parts by weight |
| alkylsulfonate solution, | |
| produced by Sanyo Chemical | |
| Industries Co., Ltd., 44 wt %) | |
| EMALEX 710 (polyoxyethylene | 0.05 parts by weight |
| alkyl ether, produced by Nihon | |
| Emulsion Co., Ltd., 100 wt %) | |
| DENACOLE EX-614B (epoxy | 0.15 parts by weight |
| compound, produced by Nagase | |
| Chemtex, effective component | |
| concentration: 100 wt %) | |
| Matting agent shown in Table 1 | in an amount shown |
| | in Table 1 |
| Distilled water | 97 parts by weight |

(Formation Undercoat Layer)

On the surface of the support opposite the surface where the back layer was provided, the following coating solution was coated by a wire bar coating method and dried at 180° C. for 30 seconds to form an undercoat layer having a dry thickness of 0.2 μm.

<Coating Solution for Undercoat Layer>

| | |
|---|---|
| YODOSOL WA60 (polyurethane | 5.9 parts by weight |
| latex, produced by Nippon NSC, | |
| solid content: 40 wt %) | |
| DENACOLE EX-521 (epoxy | 0.48 parts by weight |
| compound, produced by Nagase | |
| Chemtex, effective component | |
| concentration: 100 wt %) | |
| SNOWTEX C (colloidal silica, | 2.4 parts by weight |
| produced by Nissan Chemicals | |
| Industries, Ltd., solid | |
| content: 20 wt %) | |
| SANDED BL (aqueous sodium | 0.21 parts by weight |
| alkylsulfonate solution, | |
| produced by Sanyo Chemical | |
| Industries Co., Ltd., 44 wt %) | |
| Distilled water | 89 parts by weight |

(Formation of Light-to-Heat Conversion Layer)

The following mixed solution was stirred together with glass beads in a paint shaker for 30 minutes to disperse carbon black and after removing the glass beads by filtration, 0.005 g of fluorine-containing surfactant Megafac F177 (produced by Dai-Nippon Ink & Chemicals, Inc.) was added thereto and stirred to prepare a coating solution for light-to-heat conversion layer.

This coating solution was coated on the undercoat layer formed above, to have a dry thickness of 1.0 μn and then dried under heat at 80° C. for 2 minutes to form a light-to-heat conversion layer.

<Coating Solution for Light-to-Heat Conversion Layer>

| | |
|---|---|
| COATLON MW-060 (polyurethane, | 3.0 parts by weight |
| produced by Sanyo Chemical | |
| Industries Co., Ltd.) | |
| Carbon black (MA-230, | 2.0 parts by weight |
| produced by Mitsubishi | |
| Chemical Corporation) | |
| SOLSPERSE S24000R (produced | 0.3 parts by weight |
| by ICI) | |
| Propylene glycol monomethyl | 100.0 parts by weight |
| ether | |

(Formation of Silicone Rubber Layer)

On the light-to-heat conversion layer formed above, the following coating solution was coated and then dried under heat at 100° C. for 1 minute to form an addition-type silicone rubber layer having a dry thickness of 1.5 g/m²,

<Coating Solution for Silicone Rubber Layer>

| | | |
|---|---|---|
| α,ω-Divinylpolydimethyl- | 9.0 | parts by weight |
| siloxane (average | | |
| polymerization degree: 1,300) | | |
| (CH₃)₃SiO(SiH(CH₃)O)₈—Si(CH₃)₃ | 0.2 | parts by weight |
| Olefin-coordinated platinum | 0.1 | part by weight |
| catalyst | | |
| Controlling agent [HC≡C— | 0.2 | parts by weight |
| C(CH₃)₂—O—Si(CH₃)₃] | | |
| ISOPER (produced by Exxon | 120.0 | parts by weight |
| Chemical) | | |

In this way, waterless lithographic printing plate precursors for use in Examples 1 to 19 and Comparative Examples 1 to 8, each having good adhesion between respective layers, were obtained.

[Table 1]

TABLE 1

| | | | | Back First |
|---|---|---|---|---|
| | | | | Layer, |
| | | | | Electrically |
| | Back Second Layer, Matting Agent | | | Conducting |
| | | Average | | Particle |
| | | Particle | | Average |
| Sample | Kind | Size | Amount | Particle Size |
| Example 1 | CHEMIPEARL | 0.6 μm | 0.02 parts | 0.05 μm |
| | W-950 (produced by | | by weigh | |
| Example 2 | Mitsui Chemicals, | | 0.03 parts | |
| | Inc., solid | | by weight | |
| Example 3 | content: 40 wt %) | | 0.05 parts | |
| | | | by weight | |
| Example 4 | | | 0.06 parts | |
| | | | by weight | |
| Example 5 | CHEMIPEARL | 1.0 μm | 0.02 parts | |
| | W-700 (produced by | | by weight | |
| Example 6 | Mitsui Chemicals, | | 0.03 parts | |
| | Inc., solid | | by weight | |
| Example 7 | content: 40 wt %) | | 0.05 parts | |
| | | | by weight | |
| Example 8 | | | 0.06 parts | |
| | | | by weight | |
| Example 9 | CHEMIPEARL | 3.0 μm | 0.02 parts | |
| | W-300 (produced by | | by weight | |
| Example 10 | Mitsui Chemicals, | | 0.03 parts | |
| | Inc., solid | | by weight | |
| Example 11 | content: 40 wt %) | | 0.05 parts | |
| | | | by weight | |
| Example 12 | | | 0.06 parts | |
| | | | by weight | |
| Example 13 | CHEMIPEARL | 0.6 μm | 0.03 parts | no |
| | W-950 | | by weight | electrically |
| Example 14 | | | 0.05 parts | conducting |
| | | | by weight | particle |
| Example 15 | | | 0.06 parts | |
| | | | by weight | |
| Example 16 | CHEMIPEARL | 0.6 μm | 0.02 parts | 0.10 μm |
| | W-950 | | by weight | |
| Example 17 | | | 0.03 parts | |
| | | | by weight | |
| Example 18 | | | 0.05 parts | |
| | | | by weight | |
| Example 19 | | | 0.06 parts | |
| | | | by weight | |
| Comparative | no matting agent | | | no |
| Example 1 | | | | electrically |
| | | | | conducting |
| | | | | particle |
| Comparative | no matting agent | | | 0.05 μm |
| Example 2 | | | | |
| Comparative | SNOWTEX ZL | 0.1 μm | 0.03 parts | |
| Example 3 | (produced by | | by weight | |
| Comparative | Nissan Chemicals | | 0.06 parts | |
| Example 4 | Industries, Ltd., | | by weight | |
| | solid content: 40 | | | |
| | wt %) | | | |
| Comparative | MX-500 (produced | 5.0 μm | 0.006 parts | |
| Example 5 | by The Soken | | by weight | |
| Comparative | Chemical & | | 0.01 parts | |
| Example 6 | Engineering Co., | | by weight | |
| | Ltd.) | | | |
| Comparative | CHEMIPEARL | 0.6 μm | 0.003 parts | |
| Example 7 | W-950 | | by weight | |
| Comparative | | | 0.16 parts | |
| Example 8 | | | by weight | |

[Evaluation of Waterless Printing Plate Precursor]

(Evaluation of Plate-Spooling Amount and Four-Color Registration)

The obtained waterless lithographic printing plate precursors for use in Examples of the present invention and Comparative Examples each was formed into a roll form having a length large enough to produce and print a plurality of printing plates and mounted on a full-color printing system “Quickmaster DI46-411 manufactured by Heidelberg. On this press, a series of operations, that is, (1) exposure, (2) removal of silicone debris in the exposed area, (3) printing and (4) plate-spooling for feeding a printing plate precursor for next plate-making, were continuously performed several times, and the four-color registration of each plate-making was evaluated. Thereafter, the plates after plate-making were taken out and the plate-spooling amount was evaluated by measuring the interval of images. In the evaluation of four-color registration, the positional slippage of four-color registration was observed by a magnifier at a magnification of 2,000. The results are shown in Table 2.

(Dynamic Friction Coefficient on Back Surface)

The dynamic friction coefficient between the back surface after the waterless lithographic printing plate precursor was subjected to humidity conditioning at 25° C. and 50% RH for 2 hours, and a member subjected to the same surface processing as the plate cylinder surface of Quickmaster DI46-4 was measured by using HEIDON-14 manufactured by Shinto Scientific Co., Ltd. under a load of 200 g at a measuring speed of 600 mm/min. The results are shown in Table 2.

[Table 2]

TABLE 2

| | Dynamic Friction | Plate- | |
|---|---|---|---|
| | Coefficient on Back | Spooling | |
| Sample | Surface | Amount | Registration |
| Example 1 | 0.25 | ◯ | B |
| Example 2 | 0.23 | ◯ | A |
| Example 3 | 0.21 | ◯ | A |
| Example 4 | 0.20 | ◯ | A |
| Example 5 | 0.24 | ◯ | A |
| Example 6 | 0.22 | ◯ | A |
| Example 7 | 0.20 | ◯ | A |
| Example 8 | 0.19 | ◯ | B |
| Example 9 | 0.22 | ◯ | A |
| Example 10 | 0.20 | ◯ | A |
| Example 11 | 0.18 | ◯ | B |
| Example 12 | 0.17 | ◯ | B |
| Example 13 | 0.25 | ◯ | B |
| Example 14 | 0.24 | ◯ | A |
| Example 15 | 0.22 | ◯ | A |
| Example 16 | 0.23 | ◯ | A |
| Example 17 | 0.21 | ◯ | A |
| Example 18 | 0.19 | ◯ | A |
| Example 19 | 0.18 | ◯ | B |
| Comparative | 0.30 | shortage | D |
| Example 1 | | | |
| Comparative | 0.28 | shortage | D |
| Example 2 | | | |
| Comparative | 0.28 | shortage | D |
| Example 3 | | | |
| Comparative | 0.27 | shortage | C |
| Example 4 | | | |
| Comparative | 0.16 | excess | C |
| Example 5 | | | |
| Comparative | 0.13 | excess | D |
| Example 6 | | | |
| Comparative | 0.27 | shortage | C |
| Example 7 | | | |
| Comparative | 0.15 | excess | C |
| Example 8 | | | |

(Note in Table 2)
Ranking of Registration (A, B: allowable)
A: very good with slippage of 0 μm
B: allowable with slippage of 20 μm or less
C: no good level with slippage of 21 to 100 μm
D: very bad with slippage of 101 μm or more

As apparent from Table 2, in the waterless lithographic printing plate precursor of Examples 1 to 19 according to the present invention, the plate-spooling amount (plate-feeding property) and the four-color registration both were good and each was satisfied, whereas in the waterless lithographic printing plate precursor of Comparative Examples 1 to 8, unsatisfactory results were exhibited.

### Examples 20 to 22 and Comparative Examples 9 and 10

Waterless lithographic printing plate precursors for use in Examples 20 to 22 and Comparative Examples 9 and 10 were produced in the same manner as the waterless lithographic printing plate precursor used in Example 1 except that the following back second layer, undercoat layer and light-to-heat conversion layer were provided in place of the back second layer, undercoat layer and light-to-heat conversion layer in the waterless lithographic printing plate precursor used in Example 1.

<Coating Solution for Back Second Layer>

| | |
|---|---|
| CHEMIPEARL S-120 (polyolefin- | 1.6 parts by weight |
| base latex, produced by Mitsui | |
| Chemicals, Inc., solid | |
| content: 27 wt %) | |
| SNOWTEX C (colloidal silica, | 1.1 parts by weight |
| produced by Nissan Chemicals | |
| Industries, Ltd., solid | |
| content: 20 wt %) | |
| SANDED BL (aqueous sodium | 0.12 parts by weight |
| alkylsulfonate solution, | |
| produced by Sanyo Chemical | |
| Industries Co., Ltd., 44 wt %) | |
| EMALEX 710 (polyoxyethylene | 0.05 parts by weight |
| alkyl ether, produced by Nihon | |
| Emulsion Co., Ltd., 100 wt %) | |
| DENACOLE EX-614B (epoxy | 0.02 parts by weight |
| compound, produced by Nagase | |
| Chemtex, effective component | |
| concentration: 100 wt %) | |
| CHEMIPEARL W-950 (polyolefin- | in an amount shown |
| base matting agent, produced | in Table 3 |
| by Mitsui Chemicals, Inc., | |
| average particle size: 0.6 μm) | |
| NIKKOL SCS (sodium | in an amount shown |
| cetylsulfate, produced by | in Table 3 |
| Nikko Chemicals Co., Ltd.) | |
| Distilled water | 97 parts by weight |

<Coating Solution for Undercoat Layer>

| | |
|---|---|
| TAKERACK W-6061 (polyurethane | 7.9 parts by weight |
| latex, produced by Mitsui | |
| Takeda Chemicals, Inc., solid | |
| content: 30 wt %) | |
| DENACOLE EX-521 (epoxy | 0.48 parts by weight |
| compound, produced by Nagase | |
| Chemtex, effective component | |
| concentration: 100 wt %) | |
| Nipol UFN1008 (polystyrene | 0.04 parts by weight |
| matting agent, produced by | |
| ZEON Corporation, average | |
| particle size: 2.0 μm, solid | |
| content: 20 wt %) | |
| EMALEX 710 (polyoxyethylene | 0.07 parts by weight |
| alkyl ether, produced by Nihon | |
| Emulsion Co., Ltd., 100 wt %) | |
| Distilled water | 92 parts by weight |

<Coating Solution for Light-to-Heat Conversion Layer>

| | |
|---|---|
| Reaction product of diphenyl- | 3.0 parts by weight |
| methane diisocyanate (5 mol), | |
| polypropylene glycol (1 mol) | |
| and 2,2′-dimethylolpropanoic | |
| acid (4 mol) | |
| MA-230 (carbon black, | 2.0 parts by weight |
| produced by Mitsubishi | |
| Chemical Corporation) | |
| SOLSPERSE S24000R (produced | 0.15 parts by weight |
| by ICI) | |
| SOLSPERSE S17000 (produced by | 0.15 parts by weight |
| ICI) | |
| KF333 (surfactant, produced | 0.006 parts by weight |
| by Dai-Nippon Ink & | |
| Chemicals, Inc.) | |
| Methyl ethyl ketone | 29 parts by weight |
| Propylene glycol monomethyl | 15 parts by weight |
| ether | |

[Table 3]

TABLE 3

| | Amount of | |
|---|---|---|
| Sample | CHEMIPEARL W-950 | Amount of NIKKOL SCS |
| Example 20 | 0.04 parts by weight | none |
| Example 21 | | 0.04 parts by weight |
| Example 22 | | 0.08 parts by weight |
| Comparative | | 0.12 parts by weight |
| Example 9 | | |
| Comparative | none | 0.12 parts by weight |
| Example 10 | | |

[Evaluation of Waterless Lithographic Printing Plate Precursor”]

(Evaluation of Dynamic Friction Coefficient on Back Surface, Plate-Spooling Amount and Four-Color Registration]

The obtained waterless lithographic printing plate precursors were evaluated on the dynamic friction coefficient on back surface, plate-spooling amount and four-color registration by the same method as in Examples 1 to 19. The results are shown in Table 4.

[Table 4]

TABLE 4

| | Dynamic Friction | | |
|---|---|---|---|
| | Coefficient on Back | Plate-Spooling | |
| Sample | Surface | Amount | Registration |
| Example 20 | 0.22 | ◯ | A |
| Example 21 | 0.20 | ◯ | A |
| Example 22 | 0.18 | ◯ | B |
| Comparative | 0.16 | shortage | D |
| Example 9 | | | |
| Comparative | 0.27 | shortage | D |
| Example 10 | | | |

As apparent from Table 4, in the waterless lithographic printing plate precursor of Examples 20 to 22 according to the present invention, the plate-feeding property and the four-color registration both were good, whereas in the waterless lithographic printing plate precursor of Comparative Examples 9 and 10, unsatisfactory results were exhibited.

This reveals that it is important for obtaining good plate-feeding property and good registration to adjust the dynamic friction coefficient on the back surface of the waterless lithographic printing plate precursor against the plate cylinder surface to fall in a specific range.

### Comparative Example 11

A waterless lithographic printing plate precursor for use in Comparative Example 11 having good adhesion between respective layers was prepared in the same manner as the waterless lithographic printing plate precursor used in Example 20 except that a 178 μm-thick white polyester film “Melinex 329” (produced by DuPont) containing BaSO₄ filler was used in place of the support of the waterless lithographic printing plate precursor used in Example 20 and the back first and second layers were not provided.

The obtained waterless lithographic printing plate precursor was evaluated on the dynamic friction coefficient on back surface, plate-spooling amount and four-color registration by the same method as in Examples 1 to 19.

As a result, the dynamic friction coefficient against the plate cylinder surface was as low as 0.15 and excess plate-feeding property and large slippage of registration in the rank D were exhibited.

According to the waterless lithographic printing plate precursor of the present invention, printing of not causing conveyance trouble, four-color registration failure or the like can be realized even in an embodiment where a waterless lithographic printing plate precursor in the roll form is loaded inside a plate cylinder of a press and supplied onto the plate cylinder while directing the image-forming surface to the surface side, the formation of an image pattern and plate-making of a printing plate are performed on the press by scan-exposing an image with an infrared laser ray based on digital signals, and printing is performed by using the printing plate on the same press.

This application is based on Japanese Patent application JP 2003-139323, filed May 16, 2003, the entire content of which is hereby incorporated by reference, the same as if set forth at length.

What is claimed is:

1. A lithographic printing plate precursor requiring no fountain solution, comprising, in this order:
a back layer containing a particle having an average particle size of 0.2 to 4.0 μm;
a support;
a light-to-heat conversion layer; and
a silicone rubber layer,
wherein a dynamic friction coefficient between a surface of the back layer and a surface of a plate cylinder of a press on which the lithographic printing plate precursor is to be loaded is from 0.17 to 0.26.

2. The lithographic printing plate precursor requiring no fountain solution according to claim 1, wherein the particle is a matting agent.

3. The lithographic printing plate precursor requiring no fountain solution according to claim 1, wherein the back layer further contains a metal oxide particle.

4. The lithographic printing plate precursor requiring no fountain solution according to claim 3, wherein the metal oxide particle has an average particle size of 0.02 to 0.2 μm.

5. The lithographic printing plate precursor requiring no fountain solution according to claim 3, wherein the metal oxide particle has an average particle size of 0.03 to 0.15 μm.

6. The lithographic printing plate precursor requiring no fountain solution according to claim 3, wherein the metal oxide particle has an average particle size of 0.04 to 0.08 μm.

7. The lithographic printing plate precursor requiring no fountain solution according to claim 1, wherein the particle has an average particle size of 0.3 to 3.0 μm.

8. The lithographic printing plate precursor requiring no fountain solution according to claim 1, wherein the particle has an average particle size of 0.5 to 1.0 μm.

9. The lithographic printing plate precursor requiring no fountain solution according to claim 1, wherein the surface of the back layer has a Bekk smoothness of 50 to 500 seconds.

10. The lithographic printing plate precursor requiring no fountain solution according to claim 1, wherein the surface of the back layer has a Bekk smoothness of 60 to 450 seconds.

11. The lithographic printing plate precursor requiring no fountain solution according to claim 1, wherein the light-to-heat conversion layer contains a carbon black.

12. A printing method comprising, in this order:
imagewise irradiating a lithographic printing plate precursor requiring no fountain solution, comprising, in this order: a back layer containing a particle having an average particle size of 0.2 to 4.0 μm.; a support; a light-to-heat conversion layer; and a silicone rubber layer, wherein a dynamic friction coefficient between a surface of the back layer and a surface of a plate cylinder of a press on which the lithographic printing plate precursor is to be loaded is from 0.17 to 0.26, with a laser;
removing the silicone rubber layer in a laser-irradiated part; and
performing a printing.
